(19) United States
(12) Patent Application Publication
(10) Pub. No.: US 2022/0224194 A1
(43) Pub. Date: Jul. 14, 2022

(54) DRIVE, INCLUDING AN ELECTRIC MOTOR HAVING A ROTOR SHAFT, ANGLE SENSOR, AND HOOD PART AND CONNECTION MODULE, AND METHOD FOR PRODUCING A DRIVE

(71) Applicant: SEW-EURODRIVE GMBH & CO. KG, Bruchsal (DE)

(72) Inventors: Jochen RIESER, Karlsruhe (DE); Tobias STARK, Östringen (DE); Gerolf FICHTNER-PFLAUM, Kraichtal-Unteröwisheim (DE)

(73) Assignee: SEW-EURODRIVE GMBH & CO. KG, Bruchsal (DE)

(21) Appl. No.: 17/613,274

(22) PCT Filed: May 18, 2020
(86) PCT No.: PCT/EP2020/025227

§ 371 Date: Nov. 22, 2021

(30) Foreign Application Priority Data
May 21, 2019 (DE) 102019003544.5

(51) Int. Cl. H02K 5/22; H02K 5/20; H02K 9/06; H02K 11/21

(52) U.S. Cl. CPC H02K 5/225; H02K 11/21; H02K 9/06; H02K 5/207

(57) ABSTRACT

In a drive includes an electric motor having a rotor shaft, an angle sensor, and a hood part and a connection module, and a method for producing a drive, the connection module has a top part, a holding part, and a bottom part, the bottom part is detachably connected to the top part, the bottom part is detachably connected to the holding part, the holding part projecting through a slot of the hood part, e.g., a slot aligned in parallel with the axis of rotation of the rotor shaft, and the connection module is fastened to the hood part by clamping the hood part between the bottom part and the holding part.

### FIELD OF THE INVENTION

The present invention relates to a drive having an electric motor with a rotor shaft, an angle sensor, and a hood part and a connection module, and also relates to a method for producing a drive.

### BACKGROUND INFORMATION

In certain conventional systems, an electric motor with an angle sensor can be provided in a drive.

German Patent Document No. 199 18 652 describes a rotatable connection unit for an electric modular unit.

German Patent Document No. 295 02 565 describes an electric machine.

German Patent Document No. 31 22 655 describes an actual-value sensor device.

German Document No. 102 38 336 describes a motor series.

German Patent Document No. 10 2013 002 049 describes a sensor system.

German Patent Document No. 10 2004 036 903 describes an encoder module.

German Patent Document No. 20 2009 000 899 describes an attachment device for attaching a cable to a housing passage.

German Patent Document No. 10 2008 028 658 describes an electric motor having a sensor.

German Patent Document No. 10 2014 007 212 describes a system for acquiring the angular position of a shaft of an electric motor.

### SUMMARY

Example embodiment of the present invention provide for uncomplicated maintenance work on a drive.

According to an example embodiment of the present invention, a drive has an electric motor with a rotor shaft, an angle sensor, and a hood part and a connection module. The angle sensor is adapted to acquire the rotary position of the rotor shaft. The hood part is attached to a housing part of the electric motor, e.g., directly or indirectly. The connection module has a top part, a holding part, and a bottom part, the bottom part is detachably connected to the top part, the bottom part is detachably connected to the holding part, and the holding part projects through a slot of the hood part, e.g., a slot that is aligned in parallel with the axis of rotation of the rotor shaft. The connection module is attached to the hood part by clamping the hood part between the bottom part and the holding part, e.g., the region of the hood part clamped between the bottom part and the holding part being elastically deformed.

This has the advantage of achieving an interface on the hood part with the aid of the connection module. A simple installation, initial operation or maintenance is therefore possible. This is because the connection cable coming from the outside is able to be removed by separating the top part from the bottom part, which merely requires the severing of a plug and socket connection. When installing the hood part, which protects the angle sensor and conducts a cool airflow supplied by a fan wheel, the cable coming from the angle sensor is furthermore able to be plugged into the bottom part. Thus, the electrical connections are separated by the two plug-in connections according to the mechanical structure of the drive, which therefore means that electrical interfaces are assigned to the mechanical interfaces.

According to example embodiments, the angle sensor is situated in the spatial region surrounded by the hood part, and the bottom part and the top part are situated outside this spatial region. This has the advantage that the angle sensor is placed so that it is protected by the hood part.

According to example embodiments, protrusions are arranged on the bottom part on the side of the bottom part facing the hood part, which are pressed against the hood part, e.g., into depressions on the hood part, e.g., into depressions formed by the projections, such that the hood part is plastically deformed by the projections. This has the advantage that the projections press themselves into the hood part when the bayonet connection is activated. This is because by the end of the rotary movement, the hood part is clamped between the projections of the bottom part and the holding part, which thereby provides for the impressing. When the bayonet connection is established, i.e., during the rotary movement, an increasing friction thus has to be overcome, and by the end of the rotary movement, the projections have been pressed into the depressions made in the hood part in a form-fitting manner. Although a change may occur in the elastic preloading of the hood part and in the coefficient of friction in the subsequent operation, the projections are form-fittingly snapped into the depressions. As a result, the connection is stable even during temperature variations.

According to example embodiments, the holding part has an annular groove in which a sealing ring is accommodated. The holding part, for example, projects into a recess of the bottom part and the holding part is positioned against a step of the recess, the annular groove, for example, being situated within the recess. The sealing ring is positioned between the holding part and the bottom part, and, for example, seals the holding part from the bottom part. This has the advantage that on the one hand, the holding part and the bottom part are able to be tightly connected and on the other hand, the bottom part is rotatable relative to the holding part. The holding part and the bottom part are thus connectable to each other in different rotary positions.

According to example embodiments, the projections are evenly spaced apart from one another in the circumferential direction in relation to the ring axis of the annular groove. This has the advantage that a uniform contact pressure is able to be exerted on the bottom part.

According to example embodiments, a bayonet connection between the hood part and the holding part is induced with the aid of guide areas provided on the holding part, e.g., together with the bottom part. This offers the advantage that it allows for a simple and secure connection of the connection module to the hood part. This is because it requires only a rotary movement by which an ever greater frictional force and ultimately a positive fit is able to be induced.

According to example embodiments, first guide areas, which are aligned in parallel with one another, and second guide areas, which are aligned in parallel with one another and, for example, abut the first guide areas, are arranged on the holding part, and the first guide areas have a non-vanishing angle with respect to the second guide areas, e.g., such that after the holding part has been inserted into the slot of the hood part in the direction of the ring axis, the boundary of the slot rests against the first guide areas, and after a subsequent rotary movement of the holding part about the ring axis has taken place, e.g., the second guide areas rather than the first guide areas are resting against the boundary of the slot, and an, e.g., axial snap-in and/or clip-in take(s) place at the conclusion of the following rotary movement. This has the advantage that the holding part is first guided through the slot so that the hood part rests against the first guide areas by its end region bounding the slot. The two first guide areas, for example, have a planar configuration and as two guide areas that are spaced apart from each other in their normal direction, touch two areas of the boundary. By rotating the annular groove of the holding part about the ring axis, second guide areas rather than the first guide areas then come to rest against the boundary. In this transition of the abutting, i.e., from the first to the second guide areas, the hood part, which previously had a curved configuration, is clamped to an increasing extent between the bottom part, e.g., between the projections of the bottom part, and the holding part. The curvature of the hood part becomes increasingly straighter in the process, i.e., is preloaded. With the aid of the force elastically generated by the preloading, the projections are pressed into the material of the hood part and thus form depressions in which they are retained in a form-fitting manner.

According to example embodiments, first guide areas that are aligned in parallel with one another, and second guide areas that are aligned in parallel with one another and, for example, abut the first guide areas, are arranged on the holding part. The first guide areas have a non-vanishing angle with respect to the second guide areas, and the boundary of the slot of the hood part rests against the second guide areas. The extension of the region of the holding part situated within the hood part is broader in a direction perpendicular to the second guide areas than the width of the slot, e.g., in a direction perpendicular to the axis of rotation of the rotor shaft, and the extension of the region of the holding part situated within the hood part is narrower in a direction perpendicular to the first guide areas than the width of the slot, e.g., in a direction perpendicular to the axis of rotation of the rotor shaft. This offers the advantage that in the rotary movement of the holding part guided through the slot, the holding part is able to be form-fittingly secured at the slot of the hood part because the holding part projects beyond the slot in a transverse direction to the slot direction.

According to example embodiments, the holding part has a recess into which a sleeve part is inserted, which has an annular groove and is slipped onto the cable that includes the sensor lines of the angle sensor, and the holding part has a threaded bore into which a threaded pin is screwed and which at least partially projects into the annular groove of the sleeve part, e.g., in order to retain the sleeve part in a form-fitting manner and to reinforce the cable that is disposed in a friction-locked manner in the sleeve part. This is advantageous because a robust connection of the cable to the holding part is able to be obtained.

According to example embodiments, the bottom part has at least one uninterrupted bore through which a screw may be passed, which is optionally able to be screwed into two threaded bores that are situated in the holding part at a distance from each other, so that the bottom part is able to be aligned in two orientations that differ in relation to the holding part. This has the advantage that the outgoing section of the cable of the drive can thus be guided in different spatial directions.

According to example embodiments, the signal lines of the cable are routed to a plug connector part via a plug-in connection and a circuit board which is fixed in place in the bottom part, which is connected to a corresponding mating plug connector part fixed in place in the top part, and a connection cable is routed, e.g., in particular through a screwed cable gland situated on the top part, to a further circuit board, which is connected to the mating plug connector part and thus fixed in place in the top part. This offers the advantage that the electrical plug-in connections provide interfaces that correspond to the mechanical interfaces and allow for uncomplicated maintenance work and especially also the replacement of defective partial components.

According to example embodiments, a seal, which is disposed between the top part and the bottom part, seals the bottom part from the top part, the top part and the bottom part, e.g., being connected with the aid of screws. This has the advantage that the connection module may be provided in a configuration that is protected from explosions.

According to example embodiments, the bottom part, e.g., the region of the bottom part situated outside the hood part, has a broader extension in a direction perpendicular to the axis of rotation of the rotor shaft than the width of the slot. This offers the advantage that it is possible for the bottom part, e.g., the projections of the bottom part, to press the hood part against the holding part.

According to example embodiments, the slot width is independent of the axial position in relation to the axis of rotation of the rotor shaft, e.g., in the region covered by the first and the second guide areas in the axial direction. This has the advantage that the slot direction of the slot is arranged in parallel with the axial direction, the axial direction being the direction of the axis of rotation of the rotor shaft. The slot width is independent of the slot position. A constant slot width, i.e., a slot width that is independent of the axial slot position, is therefore implemented. In other words, the connection module is able to be fixed in place in the same manner in any location in the region of the slot.

According to example embodiments, the first and second guide areas have a planar configuration in each case, a normal of the first guide area and a normal of the second guide area defining a plane that is aligned in parallel with the axis of rotation of the rotor shaft. This offers the advantage that the boundary abuts in a flat manner because the boundary, despite being quasi one-dimensional, in the millimeter range still appears as a surface that rests against the guide areas so that a flat contact is induced.

According to example embodiments, the radial clearance of the first guide areas in relation to the axis of rotation of the rotor shaft is similar to the radial clearance of the second guide areas in relation to the axis of rotation of the rotor shaft. This is considered advantageous insofar as all guide areas are arranged in a tangential plane of the axis of rotation of the rotor shaft if their extension in the radial direction is negligible.

According to example embodiments, the hood part is made from sheet metal. This has the advantage of allowing for a simple, cost-effective production.

According to example embodiments, the wall thickness of the hood part is constant in the region that is covered by the bottom part in the axial direction and the circumferential direction in relation to the axis of rotation of the rotor shaft. This has the advantage that an elastic deflection, e.g., preloading, can be easily generated.

According to example embodiments, in its end region, e.g., axially facing away from the rotor shaft, especially the B side end region, the hood part has grating openings through which an airflow supplied by a fan wheel of the electric motor is flowing, for example, the fan wheel is connected to the rotor shaft in a torsionally fixed manner. This is considered advantageous insofar as the hood part carries out a protective function for the angle sensor and simultaneously conducts an airflow and executes a holding function for the connection module.

According to an example embodiment of the present invention, in a method for producing a drive that has an electric motor with a rotor shaft, an angle sensor, and a hood part and a connection module, which includes a top part, a holding part and a bottom part: e.g., a cable which has signal lines, especially sensor lines, and which particularly is connected to an angle sensor, is first inserted into a recess of a holding part, a sleeve part which is slipped onto the cable and connected to the cable by a frictional connection, is secured in a form-fitting manner, e.g., by a threaded pin that projects into an annular depression of the sleeve part and is screwed through a threaded bore of the holding part; in a first method step, a holding part is inserted into a recess of a bottom part and tightly connected with the aid of at least one screw and a sealing ring, which is situated in an annular groove of the holding part or the bottom part; in a second method step, the holding part is guided through an axial slot of a hood part of the drive until a boundary of the slot rests against first guide areas of the holding part that are aligned in parallel with each other; in a third method step, the bottom part, which is connected to the holding part, is rotated about the ring axis of the annular groove such that second guide areas rather than the first guide areas rest against the boundary; and e.g., in a fourth method step, a top part is placed on the bottom part and connected with the aid of screws, and a mating plug connector part which is fixed in place in the top part and connected to a connection cable is plugged into a plug connector part fixed in place in the bottom part.

This has the advantage that a rapid and simple connection of the connection module by a bayonet lock is possible despite the hood part being a thin sheet metal part and thus not offering a perfectly stable basis.

According to example embodiments, in the first method step, the screw guided through a recess of the bottom part is screwed optionally into a first or a second threaded bore of the holding part, and when the screw is screwed into the first threaded bore, the bottom part has a first spatial alignment, e.g., a rotary position, with respect to the holding part, and when the screw is screwed into the second threaded bore, the bottom part has a second spatial alignment, e.g., a rotary position, with respect to the holding part, the first alignment, for example, differing from the second alignment. This has the advantage that different spatial directions are selectable for the outgoing section of the connection cable, and more particularly, the spatial direction is selectable that is still available between the machines or devices surrounding the drive.

Further features and aspects of example embodiments of the present invention are described in greater detail below with reference to the appended schematic Figures.

### BRIEF DESCRIPTION OF THE DRAWINGS

FIG. 1 is a perspective view of a hood part 1 of a drive according to an example embodiment of the present invention with the connection module not yet installed.

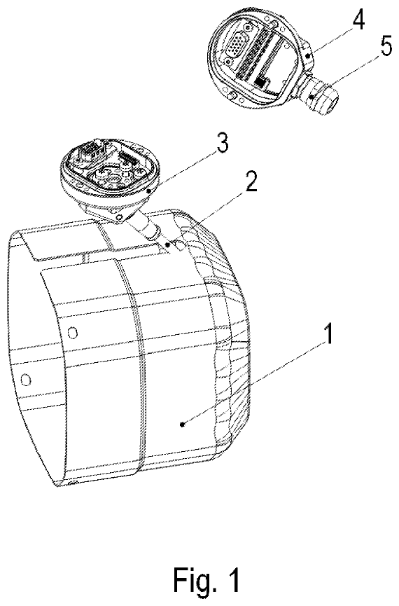

FIG. 2 is another perspective view of hood part 1 together with the assembled connection module.

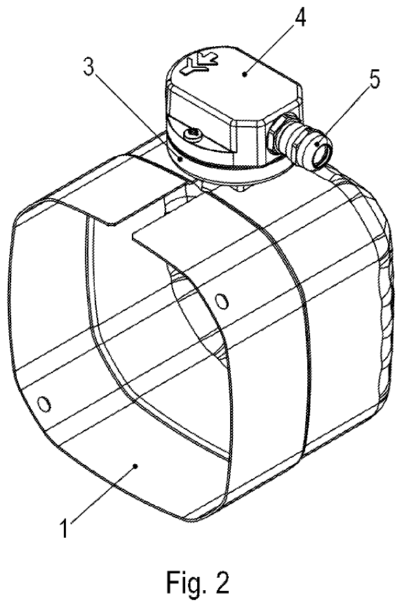

FIG. 3 is a top view associated with FIG. 2.

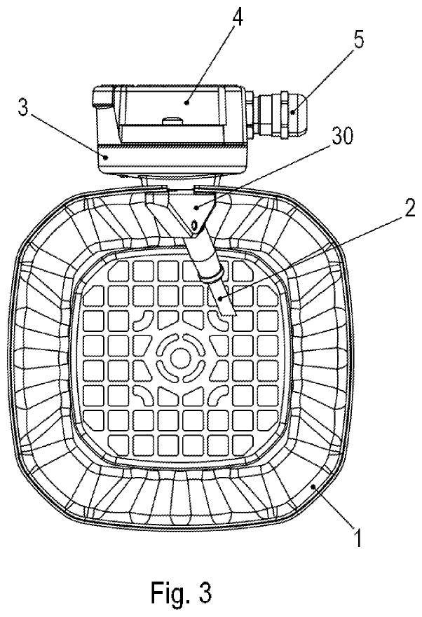

FIG. 4 is an enlarged portion of FIG. 3.

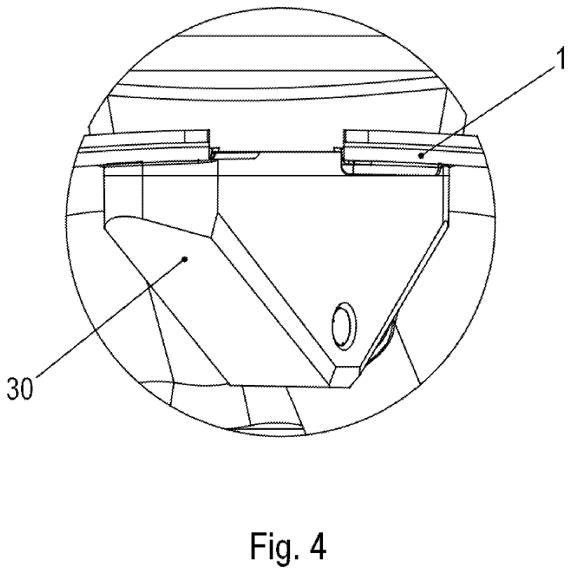

FIG. 5 is a perspective view of a holding part 30 for an attachment to the connection module.

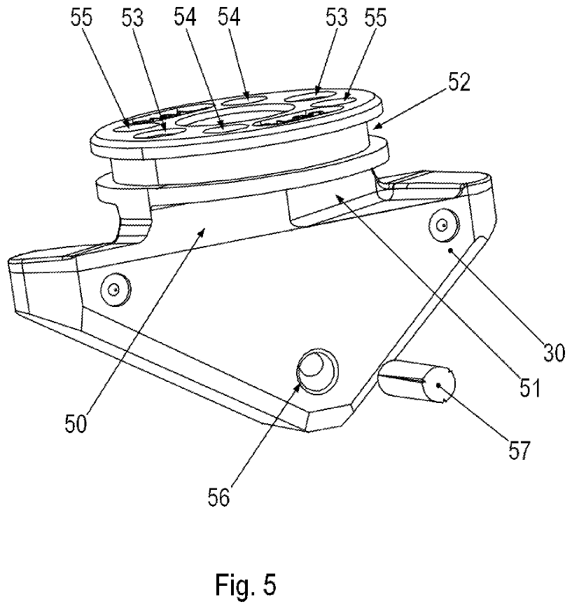

FIG. 6 is an exploded view of the parts without hood part 1.

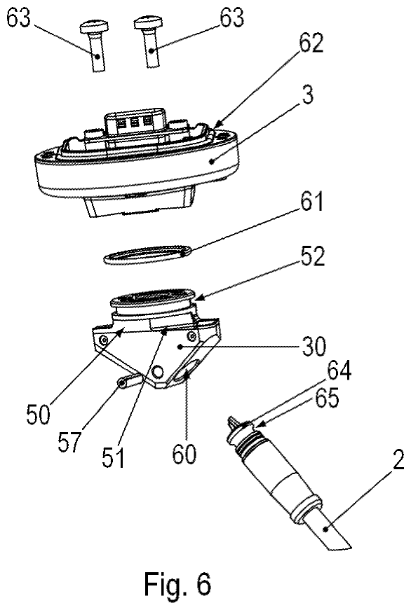

FIG. 7 is a perspective view of bottom part 3.

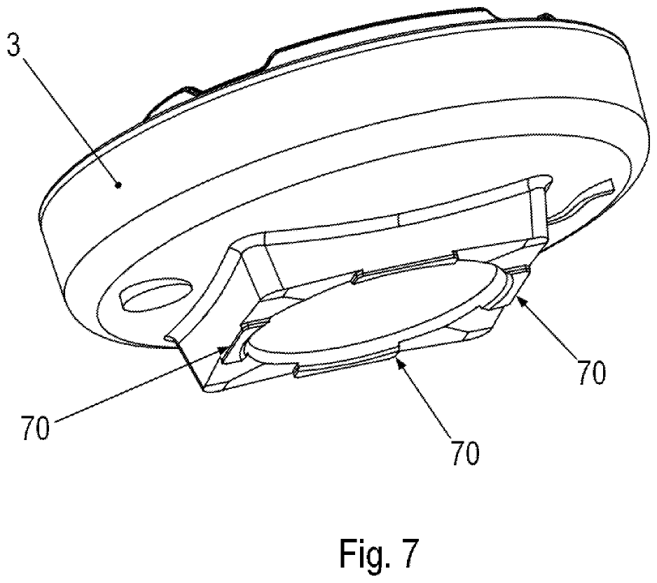

### DETAILED DESCRIPTION

As schematically illustrated in the Figures, the electric motor has on the B side a hood part 1 which surrounds, especially encases, an angle sensor, which is fixed in place on the first axial end, for example, the B-side end, of the rotor shaft.

Hood part 1 is open toward the rotor shaft and has a grating on its axial end facing away from the rotor shaft, the grating, e.g., being provided with axially uninterrupted grating openings so that an airflow supplied by a fan is able to be conducted through the grating.

At its circumference, hood part 1 has a slot, which is aligned in parallel with the axis of rotation of the rotor shaft and allows for a simple installation of the connection module.

A first part of the angle sensor is connected to the rotor shaft of the electric motor in a torsionally fixed manner and thus is rotatable relative to a second, stationary part of the angle sensor. This second part is directly or indirectly connected to the motor housing and to hood part 1.

The angle values of the rotor shaft acquired by the angle sensor are conveyed to the connection module via cable 2, which has electrical lines.

The connection module has a bottom part 3, which is provided with a top part 4 that is placed on bottom part 3 and connected by a seal 62 having a high protection rating.

On its side facing away from top part 4, bottom part 3 is provided with an uninterrupted recess, e.g., a cylindrically shaped recess in which a holding part 30 is inserted and accommodated.

For a tight connection, a sealing ring 61, which is situated between bottom part 3 and holding part 30, is accommodated in an annular groove 52 introduced in holding part 30, which thus seals holding part 30 from bottom part 3.

The region of holding part 30 that projects into the recess of bottom part 3 has a round shape and has the annular groove 52 on its outer circumference.

In relation to the ring axis of sealing ring 61 and/or annular groove 52, bottom part 3 has a radially greater extension than holding part 30.

Holding part 30 has a radially greater extension than annular groove 52.

During the assembly, holding part 30 is first connected to bottom part 3, that is to say, the annular groove is inserted into the cylindrical recess of bottom part 3 up to a step provided on the recess.

For example, with the aid of two screws 63, which are fed through axially uninterrupted bores 54 of bottom part 3 and are at least partially screwed into two threaded bores introduced in holding part 30, bottom part 3 is pressed against holding part 30 in an axial direction, i.e., connected with the aid of screws 63 in a friction-locked manner in the axial direction and connected by form-locking in the circumferential direction. The screw heads of screws 63 press bottom part 3 toward holding part 30, which is positioned against the step.

On the side facing away from bottom part 3, holding part 30 is provided with a width that is smaller than the slot introduced in hood part 30. As illustrated in the Figures, this region of holding part 30 that is guided through the slot has a triangular shape. More specifically, holding part 30 may also be referred to as a sliding block.

During the assembly, holding part 30 may thus be inserted into the slot of hood part 1 up to below the region of holding part 30 that accommodates annular groove 52.

The introduction of holding part 30 into the slot is stopped when contact is made between the region of bottom part 3 that accommodates the cylindrical recess, i.e., the region of bottom part 3 which accommodates annular groove 52, and hood part 1.

The edge of hood part 1 restricting the slot then rests against two first guide areas 50 of hood part 30, which, for example, are situated opposite each other on hood part 30. These two first guide areas 50 are aligned in parallel with each other. Situated in the same axial region as first guide areas 50 in relation to the ring axis, but, e.g., in an adjoining circumferential angle region, are second guide areas 51, which especially also have a parallel alignment with respect to each other.

However, second guide areas 51 have a non-vanishing angle relative to first guide areas 50. Since the first and second guide areas (50, 51) abut each other, holding part 30 is first inserted into the slot during the assembly so that the boundary of the slot rests against first guide areas 50, whereupon holding part 30 is rotated about the ring axis such that second guide areas 51 rather than the first guide areas rest against the boundary of the slot.

During this rotary movement, projections 70 provided on the underside of bottom part 3 facing hood part 1 exert pressure on hood part 1 made from sheet metal, so that hood part 1, which is provided with a slight curvature, is deformed and projections 70 create respective depressions in the material of hood part 1. This induces a bayonet-type lock because at the conclusion of the rotary movement, a high initial force has to be applied when reversing the rotary movement, which lifts projections 70 out of the depressions and furthermore overcomes the spring force induced by the elastic deformation.

At the conclusion of the rotary movement, the region of holding part 30 previously inserted through the slot is situated in rotated form relative to the slot and thus provides additional, form-fitting security.

A sleeve part 64, which has an annular groove 65, is slipped onto cable 2 routed from the angle sensor and connected by a clamped connection in the process. This sleeve part 64 together with the end region of cable 2, which it accommodates on the inside, is inserted into a recess 60 of holding part 30, and for a form-fitting attachment of sleeve part 64 to holding part 30, a threaded sleeve 57 is screwed into a further threaded bore terminating in recess 60, so that threaded sleeve 57 at least partly projects into annular groove 65.

In this manner, a clamped connection connects cable 2 to sleeve part 64 and secures it in the holding part in a form-fitting manner. The clamping action is furthermore reinforced by threaded sleeve 57, which exerts pressure on the wall of annular groove 65.

Via, for example, a plug-in connection, the signal lines of cable 2 are routed to a circuit board, which is situated in bottom part 3 and connected to bottom part 3.

A plug connector part is connected on the circuit board, e.g., by soldering, which is able to be plugged into a corresponding mating connector part situated in top part 4, e.g., on a further circuit board accommodated in top part 4 and connected thereto. A connection cable may be routed out of this further circuit board, the connection cable being guided to the outside by a screwed cable gland 5 disposed on top part 4.

This makes it possible to achieve a simple electrical connection and disconnection of the connection cable from the electric motor, i.e., by separating top part 4 from bottom part 3. Fore example, when maintenance work is performed, this is of particular advantage. This is because the sensor lines are accessible by separating top part 4 from bottom part 3, so that the angle sensor is able to be tested. During a further disassembly, hood part 1 can then be pulled off the rest of the drive when the clamping connection of hood part 1, which is clamped between holding part 30 and bottom part 3, has been released. The direction of the outgoing section of the cable, i.e., the orientation of the screwed cable gland, is able to be oriented in four directions because screws 63 are optionally able to be screwed into threaded bores 54 and 55, and/or top part 4 may be provided on bottom part 3 in a first alignment or in an alignment that is rotated about the ring axis by 180° with respect to the first alignment.

With the aid of screws, the plug connector part is connected to bottom part 3, and the circuit board is thereby fixed in place in bottom part 3 as well. In addition, the circuit board is fastened to the bottom part by a further screw.

In a corresponding manner, the mating plug connector part is fixed in place on top part 4 with the aid of screws and the further circuit board is thus connected to the mating plug connector part as well.

In further exemplary embodiments, instead of being able to be screwed into threaded bores 54, screws 63 may be screwed into threaded bores 55, which are situated in holding part 30 rotated by 90° about the ring axis. As a result, the bottom part is able to be positioned in different alignments, and the outgoing section of the cable, too, may thus be implemented in different directions, so that a high variance is able to be obtained using a constant number of components.

### LIST OF REFERENCE NUMERALS

1 hood part
2 cable
3 bottom part
4 top part
5 screwed cable gland
30 holding part
50 first guide area
51 second guide area
52 annular groove
53 first bore
54 second bore
55 third bore
56 threaded bore
57 threaded pin
60 recess
61 sealing ring
62 seal
63 screw
64 sleeve part
65 annular groove
70 projection

1-15. (canceled)

16. A drive, comprising:
an electric motor including a rotor shaft, an angle sensor, and a hood part; and
a connection module including a top part, a holding part, and a bottom part detachably connected to the top part and to the holding part, the holding part projecting through a slot of the hood part, the connection module being attached to the hood part by the hood part being clamped between the bottom part and the holding part.

17. The drive according to claim 16, wherein the angle sensor is adapted to acquire a rotary position of the rotor shaft, and the hood part is attached to a housing part of the electric motor.

18. The drive according to claim 16, wherein the hood part is directly or indirectly attached to the housing part of the electric motor.

19. The drive according to claim 16, wherein the slot is aligned in parallel with an axis of rotation of the rotor shaft.

20. The drive according to claim 16, wherein a region of the hood part that is clamped between the bottom part and the holding part is elastically deformed.

21. The drive according to claim 16, wherein the angle sensor is arranged in a spatial region surrounded by the hood part, and the bottom part and the top part are arranged outside the spatial region.

22. The drive according to claim 16, wherein projections are arranged on the bottom part on a side of the bottom part facing the hood part, the projections being pressed against the hood part.

23. The drive according to claim 22, wherein the projections are pressed into depressions of the hood part and/or into depressions formed by the projections such that the hood part is plastically deformed by the projections.

24. The drive according to claim 16, wherein the hood part includes an annular groove in which a sealing ring is accommodated.

25. The drive according to claim 24, wherein the holding part projects into a recess of the bottom part and the holding part is positioned against a step of the recess, the annular groove being arranged in the recess, the sealing ring being arranged between the holding part and the bottom part and sealing the holding part from the bottom part.

26. The drive according to claim 22, wherein the hood part includes an annular groove in which a sealing ring is accommodated, and the projections are evenly spaced apart from one another in a circumferential direction in relation to a ring axis of the annular groove.

27. The drive according to claim 16, wherein a bayonet lock is provided between the hood part and the holding part, together with the bottom part, with the aid of guide areas provided on the holding part.

28. The drive according to claim 27, wherein first guide areas, which are aligned in parallel with one another, and second guide areas, which are aligned in parallel with one another and abut the first guide areas, are arranged on the holding part, the first guide areas have a non-vanishing angle with respect to the second guide areas, such that after the holding part is inserted into the slot of the hood part in a direction of a ring axis, a boundary of an edge rests against the first guide areas, and after a subsequent rotary movement of the holding part about the ring axis, the second guide areas rather than the first guide areas rest against the boundary of the slot, and an axial snap-in and/or clip-in occurs at a conclusion of a following rotary movement.

29. The drive according to claim 27, wherein first guide areas that are aligned in parallel with one another, and second guide areas that are aligned in parallel with one another and in particular abut the first guide areas, are arranged on the holding part, the first guide areas have a non-vanishing angle with respect to the first guide areas, a boundary of the slot of the hood part rests against the second guide areas, an extension of a region of the holding part arranged within the hood part is broader in a direction perpendicular to the second guide areas than a width of the slot in a direction perpendicular to an axis of rotation of the rotor shaft, the extension of the region of the holding part arranged within the hood part is narrower in a direction perpendicular to the first guide areas than the width of the slot in a direction perpendicular to the axis of rotation of the rotor shaft.

30. The drive according to claim 16, wherein the holding part includes a recess into which a sleeve part is inserted, which has an annular groove and is slipped onto a cable that includes sensor lines of the angle sensor, the holding part includes a threaded bore into which a threaded pin is screwed and which at least partially projects into an annular groove of the sleeve part to retain the sleeve part in a form-fitting manner and to reinforce the cable which is arranged in a friction-locked manner in the sleeve part.

31. The drive according to claim 16, wherein the bottom part includes at least one uninterrupted bore through which a screw is passable and is screwable into two threaded bores that are arranged in the holding part at a distance from each other so that the bottom part is alignable in two orientations that differ in relation to the holding part.

32. The drive according to claim 31, wherein the signal lines of the cable are routed to a plug connector part via a plug-in connection and a circuit board which is fixed in place in the bottom part, which is connected to a corresponding mating plug connector part which is fixed in place in the top part, and a connection cable is routed, through a screwed cable gland arranged on the top part, to a further circuit board, which is connected to the mating plug connector part and is fixed in place in the top part.

33. The drive according to claim 16, wherein a seal, which is arranged between the top part and the bottom part, seals the bottom part from the top part, the top part and the bottom part being screw connected.

34. The drive according to claim 16, wherein the bottom part, in a region of the bottom part arranged outside the hood part, has a broader extension in a direction perpendicular to an axis of rotation of the rotor shaft than a width of the slot, and/or a slot width is independent of an axial position in relation to the axis of rotation of the rotor shaft, in region covered by first and the second guide areas in an axial direction.

35. The drive according to claim 16, wherein first and second guide areas have a planar configuration, and a normal of the first guide area and a normal of the second guide area define a plane that is aligned in parallel with an axis of rotation of the rotor shaft.

36. The drive according to claim 35, wherein, in relation to the axis of rotation of the rotor shaft, a radial clearance of the first guide areas is similar to a radial clearance of the second guide areas in relation to the axis of rotation of the rotor shaft.

37. The drive according to claim 16, wherein (a) the hood part is made from sheet metal, (b) a wall thickness of the hood part is constant in a region that is covered by the bottom part in a axial direction and a circumferential direction in relation to an axis of rotation of the rotor shaft, and/or (c) in an end region, axially facing away from the rotor shaft, the hood part includes grating openings through which an airflow supplied by a fan wheel of the electric motor flows.

38. The drive according to claim 37, wherein the fan wheel is connected to the rotor shaft in a torsionally fixed manner.

39. A method for producing a drive as recited in claim 16, comprising:
inserting a cable that includes signal lines that is connected to the angle sensor into a recess of the holding part, a sleeve part which is slipped onto the cable and connected to the cable by a frictional connection, is secured in a form-fitting manner, by a threaded pin that projects into an annular depression of the sleeve part and is screwed through a threaded bore of the holding part;
inserting the holding part into a recess of the bottom part and tightly connecting the holding part with the aid of at least one screw and a sealing ring, which is arranged in an annular groove of the holding part or the bottom part;
guiding the holding part through an axial slot of the hood part of the drive until a boundary of the slot rests against first guide areas of the holding part that are aligned in parallel with each other;
rotating the bottom part, which is connected to the holding part, about a ring axis of the annular groove such that second guide areas rather than the first guide areas rest against the boundary; and
placing the top part on the bottom part and connecting the top part with the aid of screws, and plugging a mating connector part, which is fixed in place in the top part and connected to a connection cable, into a plug connector part fixed in place in the bottom part.

40. The method according to claim 39, wherein the screw guided through a recess of the bottom part is screwed into a first or a second threaded bore of the holding part, and when the screw is screwed into the first threaded bore, the bottom part has a first spatial alignment and/or a rotary position with respect to the holding part, and when the screw is screwed into the second threaded bore, the bottom part has a second spatial alignment and/or a rotary position with respect to the holding part, the first alignment in particular differing from the second alignment.
